(19) United States
(12) Patent Application Publication
(10) Pub. No.: US 2004/0258795 A1
(43) Pub. Date: Dec. 23, 2004

(54) Injection molding nozzle with separate nozzle flange

(76) Inventors: Hans Guenther, Georgetown (CA); Helen Verriet, Mississauga (CA); Glenn Roy Sterritt, Georgetown (CA)

Correspondence Address: STERNE, KESSLER, GOLDSTEIN & FOX PLLC, 1100 NEW YORK AVENUE, N.W., WASHINGTON, DC, 20005, US

(21) Appl. No.: 10/873,456

(22) Filed: Jun. 23, 2004

Related U.S. Application Data
(60) Provisional application No. 60/480,404, filed on Jun. 23, 2003.

(51) Int. Cl. B29C 45/20

(52) U.S. Cl. 425/569; 425/190; 249/134; 249/135

(57) ABSTRACT

A flange is provided for aligning an injection molding nozzle with a mold gate and insulating the injection molding nozzle from a mold plate. The flange is separate from the nozzle and is releasably connected to a body of the nozzle adjacent to a nozzle head. When the flange and nozzle are coupled, they can be inserted into and removed from a nozzle recess included within the mold plate as a unit.

### CROSS-REFERENCE TO RELATED APPLICATIONS

The present application claims the benefit under 35 U.S.C. §119(e) of, U.S. Provisional Application No. 60/480,404 filed Jun. 23, 2003. The disclosure of this referenced application is incorporated by reference herein in its entirety.

### BACKGROUND OF THE INVENTION

1. Field of the Invention

The present invention relates to nozzles for an injection molding apparatus. In particular, the present invention relates to injection molding nozzles having a separate collar.

2. Background of the Invention

In general, a hot runner nozzle includes a nozzle tip, a nozzle body and a nozzle head. A nozzle flange, or collar, is also usually provided to locate the nozzle body relative to a mold plate in which the nozzle is mounted.

Proper alignment of the components of an injection molding apparatus is desired for the production of quality-molded parts. If the hot runner nozzle is not properly aligned with the mold gate, sealing or gating may be adversely affected. In thermal gating applications, alignment of the nozzle tip with the mold gate is important in order to prevent leakage of the molten material. In valve gated applications, alignment of the nozzle tip with the mold gate is important because the valve pin, which is able to slide through the nozzle, must be properly aligned with the mold gate in order to close the gate effectively.

Installation and alignment of a nozzle with an integrated flange is relatively simple because there is no movement between the parts. In some applications, a flange constructed of a material different than that of the nozzle body is desired and is permanently coupled to the nozzle. An advantage of this arrangement is that a material that is less thermally conductive than the nozzle may be used to reduce the heat loss between the nozzle and the mold plate. In this way, it is possible to create a custom nozzle to match the requirements of a particular molding process.

It is often advantageous for the flange to be a separate part that is removable from the nozzle. Because the flange is not attached to the nozzle, it can be easily replaced or used with a different nozzle to suit different injection molding applications. For example, if more insulation between the nozzle and the mold plate is desired, a collar constructed from a ceramic material may be used instead of a steel collar.

With respect to systems employing separate flanges, there is a need for a flange that can be reliably connected to and properly aligned with the nozzle so that the combination of the nozzle and flange can be inserted into or removed from a mold plate as a unit. In addition, there is a need for a separate flange that is simple and efficient to install and remove from the nozzle. There is a further need for a nozzle having a separate flange that is compact so that the combination is compatible in tight pitch molding applications.

### SUMMARY OF THE INVENTION

According to one aspect of the invention, there is provided an injection molding apparatus having a manifold, a mold plate including a recess for receiving a nozzle, and a separate flange mounted on a body of the nozzle for aligning the nozzle relative to the mold plate. The flange has a surface engaging the nozzle body that aligns the nozzle within the flange. A second surface of the flange engages the mold and bears against the inner surface of the recess to align the flange within the recess. A connector is provided to releasably connect the flange to the nozzle body.

According to another aspect of the invention, a hot runner nozzle is provided that includes a nozzle body having an outer surface and a nozzle head, a separate flange mounted on the nozzle body adjacent to the nozzle head, and a connector for releasably connecting the nozzle body and the separate flange.

Further features and advantages of the invention, as well as the structure and operation of sample embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art based on the teachings contained herein.

### BRIEF DESCRIPTION OF THE FIGURES

These and other features, aspects and advantages of the present invention will become better understood with reference to the following description, appended claims, and accompanying drawings.

FIG. 1 is a cross-sectional view of a portion of an injection molding apparatus showing an injection molding nozzle and a separate flange according to one aspect of the present invention.

FIG. 2A is a schematic view showing a connector in a securing position for securing a separate flange to the nozzle of FIG. 1.

FIG. 2B is a schematic view showing the connector in FIG. 2A in a released position.

FIG. 3A is a partial cross-sectional side view showing the flange secured to the nozzle of FIG. 1.

FIG. 3B is a partial cross-sectional side view showing the flange released from the nozzle of FIG. 1.

FIG. 4A is an enlarged view of a portion 4A of FIG. 3A.

FIG. 4B is an enlarged view of a portion 4B of FIG. 3B.

FIG. 5 is a side view of a portion of the nozzle and flange combination of FIG. 1.

FIG. 6 is a partial sectional view of an injection molding apparatus.

### DETAILED DESCRIPTION OF THE INVENTION

Specific embodiments of the present invention are now described with reference to the figures, where like reference numbers indicate identical or functionally similar elements.

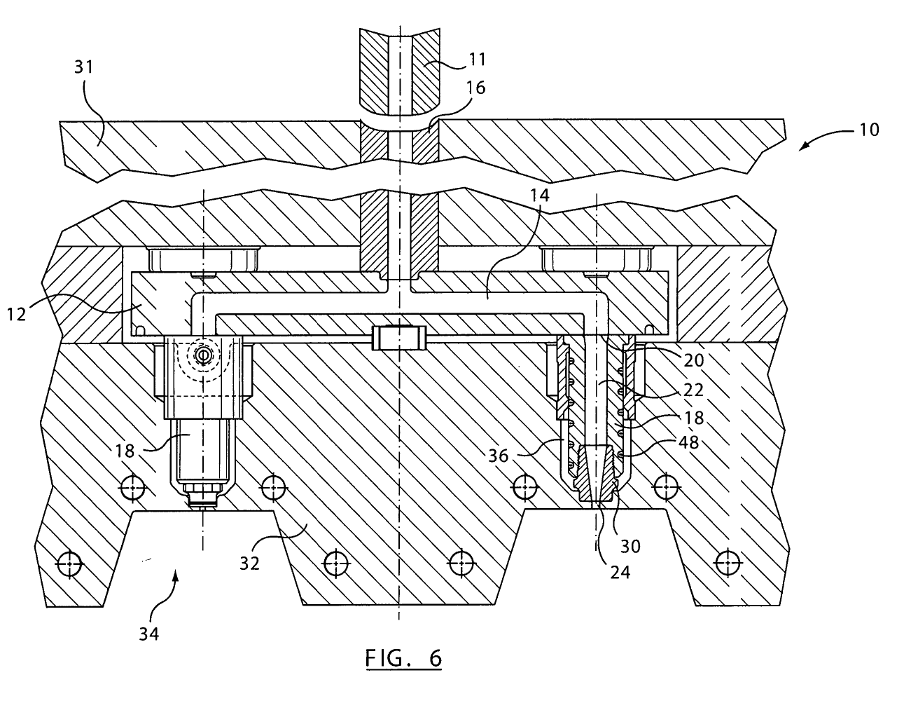

Referring first to FIG. 6, one example of an injection molding apparatus 10 in which the present invention may be utilized is shown. The injection molding apparatus includes a machine nozzle 11, which introduces a melt stream under pressure into the injection molding system via a sprue bushing 16 that is positioned within a machine platen 31. From sprue bushing 16, melt flows into a manifold melt channel 14 provided in a hot runner manifold 12. In injection molding apparatus 10, manifold 12 allows the melt stream to be distributed through nozzle melt channel inlets 20 and into nozzle melt channels 22 provided in respective nozzles 18. Nozzles 18 are positioned within nozzle cavities, or recesses 36 of a mold plate 32. Each nozzle 18 is in fluid communication with a mold cavity 34 via a mold gate 24 so that the melt stream may be injected through nozzle melt channel 22 and nozzle tip 30 into mold cavities 34.

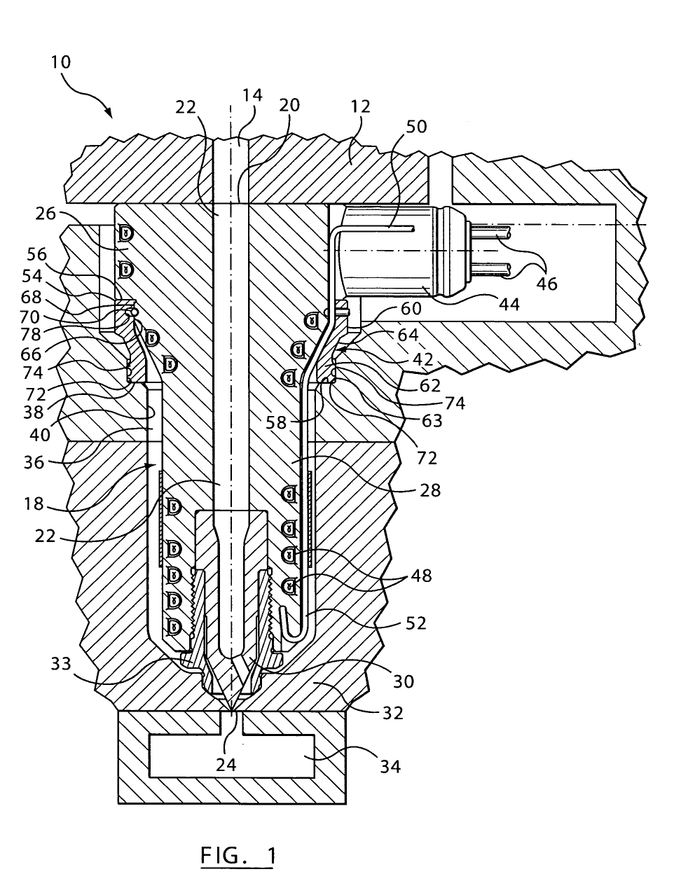

Referring to FIG. 1, a cross-sectional view of nozzle 18, provided in injection molding apparatus 10, is shown. Nozzle 18 has a nozzle melt channel inlet 20, at an upper end of nozzle melt channel 22, aligned with an outlet of manifold melt channel 14 to receive the melt stream and to deliver the melt through mold gate 24 to mold cavity 34. Nozzle 18 has a nozzle body 28, a nozzle head 26, and a nozzle tip 30. As shown, nozzle tip 30 is held in nozzle body 28 by a nozzle retainer 33. The nozzle head 26 is an upper portion of nozzle 18 that provides space for connecting a terminal connector 44. In the embodiment shown, nozzle head 26 is enlarged or has a radial dimension larger than a radial dimension of nozzle body 28. However, it shall be appreciated that nozzle head 26 need not be enlarged and may have a radial dimension that is equal to or less than the radial dimension of nozzle body 28. Injection molding apparatus 10 may include any number of such nozzles located in respective nozzle recesses 36 for transmitting melt from respective nozzle melt channel inlets 20 to respective mold gates 24.

In one embodiment, a shoulder 38 is formed on an inner wall 40 of nozzle recess 36. A generally cylindrical flange 42 surrounds a portion of the nozzle 18. Flange 42 is positioned between nozzle head 26 and shoulder 38 and aligns nozzle 18 with mold gate 24. Flange 42 supports nozzle 18 in nozzle recess 36 so that a thermally insulating space is created between nozzle 18 and mold plate 32.

As best seen in FIGS. 1 and 5, in the sample embodiment, flange 42 includes a first generally cylindrical portion 60, a transitional portion 64, and a second generally cylindrical portion 62. The portions form a single piece flange 42 with first and second cylindrical portions 60 and 62 spaced apart by transitional portion 64.

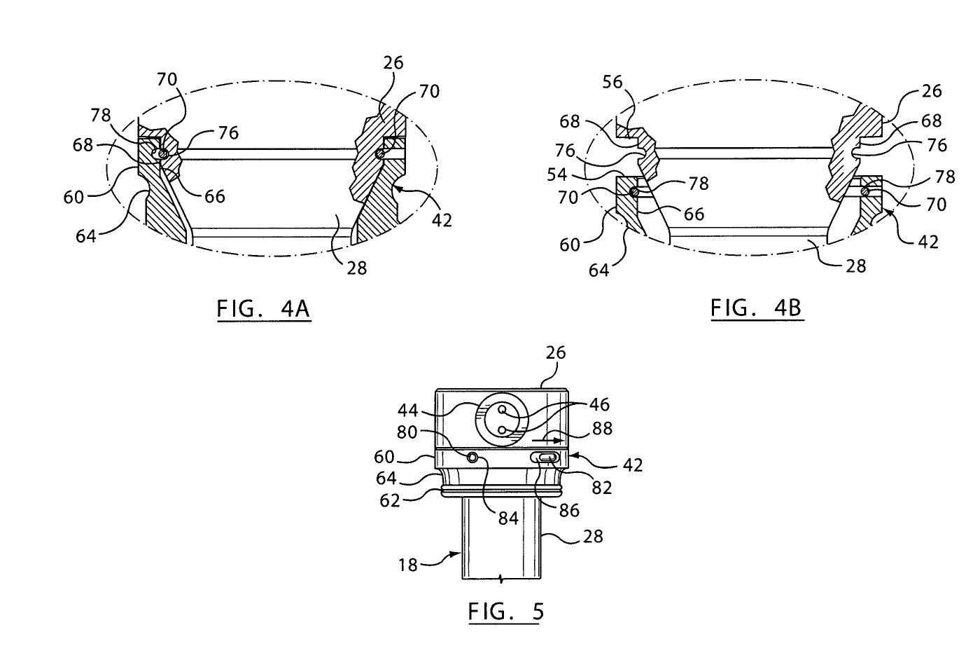

First cylindrical portion 60 has an inner surface 66 that abuts, or interfaces with, an outer surface 68 of nozzle body 28 below nozzle head 26. The contact between inner surface 66 and outer surface 68 assures that flange 42 is aligned with nozzle 18 along a longitudinal axis. First cylindrical portion 60 has a top end 54 that bears against a shoulder 56 provided at the bottom of nozzle head 26 and limits the height of flange 42 on nozzle body 28. As will be explained in greater detail below, and with further reference to FIGS. 4A and 4B, a flange groove 78 is provided in first cylindrical portion 60 of flange 42 and a nozzle groove 76 is provided in nozzle body 28 for housing a connector 70.

Transitional portion 64 is generally conical and spans from first cylindrical portion 60 to second cylindrical portion 62. Transitional portion 64 tapers inward in the direction of mold gate 24 and is located within the thermally insulating air space between nozzle 18 and mold plate 32 so that transitional portion 64 does not contact either nozzle 18 or mold plate 32.

Second cylindrical portion 62 of flange 42 has a bottom end 58 for bearing against shoulder 38 provided in nozzle recess 36. Second cylindrical portion 62 also has an outer surface 63 for abutting an inner surface 72 of nozzle recess 36. The abutment of outer surface 63 and inner surface 72 aligns the combined flange 42 and nozzle 18 with nozzle recess 36 and therefore mold gate 24. Circumferential ribs 74 may be provided on the outer surface of second cylindrical portion 62 to reduce the amount of surface area contacting inner surface 72.

Flange 42 may be made of any material known in the art for injection molding applications. In order to improve the insulation characteristics of flange 42, it may be made of a material having a low thermal conductivity such as, for example, titanium or ceramic.

In another aspect of the present invention, terminal connector 44 is located on nozzle head 26. Terminal connector 44 houses heater leads 46 for a helical nozzle heater 48 and thermocouple leads 50 for a thermocouple 52 respectively. Helical nozzle heater 48 is embedded in nozzle body 28. Although an embedded helical nozzle heater 48 is shown, other nozzle heating arrangements may be used. Thermocouple lead 50 passes through terminal connector 44 and extends to thermocouple 52 which is used to measure the temperature of nozzle 18. It shall be appreciated that any other devices known in the art for monitoring and controlling the temperature of an injection molding nozzle may be employed.

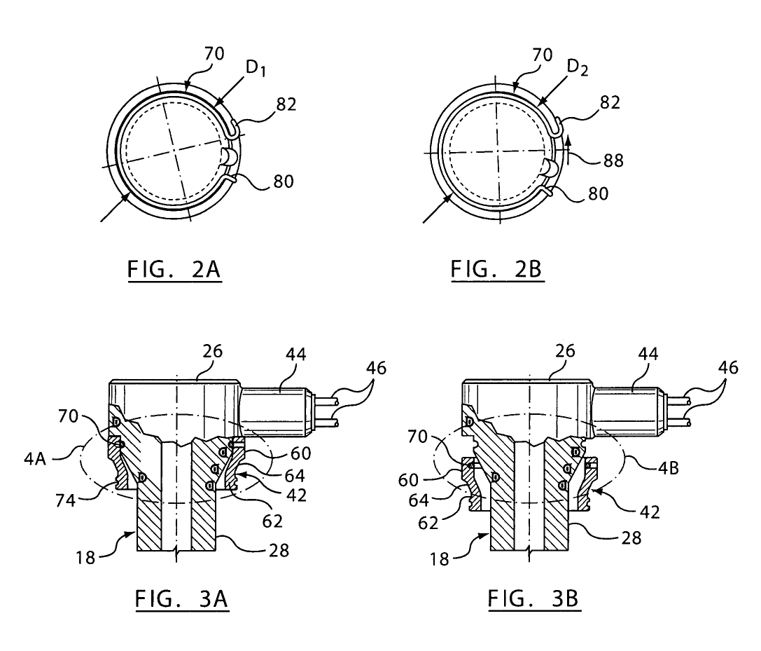

In the present embodiment, connector 70 is a generally C-shaped spring wire that is housed in flange groove 78. As shown in FIGS. 2A and 2B, connector 70 can be expanded from a first diameter D₁ to a second larger diameter D₂. Connector 70 is biased so that it has a tendency to return to the smaller first diameter when no forces are acting upon it. The two ends of connector 70 are bent outwardly and form a fixed end 80 and a movable end 82.

As best seen in FIG. 5, fixed end 80 extends into a hole 84 that extends from flange groove 78 and through at least a portion of the wall of flange 42 toward the outer surface of flange 42. Fixed end 80 prevents connector 70 from rotating within flange groove 78 with respect to flange 42. Movable end 82 extends through a slot 86 that also extends from flange groove 78 and through the wall of flange 42 toward the outer surface of flange 42.

In one aspect of the present invention, movable end 82 extends through the entire wall thickness of flange 42 so that it is accessible from the outside of flange 42. Since movable end 82 is accessible from the outside of flange 42 it is possible to apply a force in a direction 88, as shown in FIGS. 2B and 5, to connector 70 by hand.

Flange groove 78 and connector 70 are sized so that when force in direction 88 is applied to movable end 82, connector 70 becomes seated entirely within flange groove 78, as shown in FIGS. 3B and 4B. When no force is applied to movable end 82, connector 70 is biased inwardly such that connector 70 extends further inward than inner surface 66 of first cylindrical portion 60 of flange 42, as shown in FIG. 4A.

Since connector 70 is located partially in nozzle groove 76 and simultaneously partially in flange groove 78, connector 70 intersects outer surface 68 of nozzle body 28 and inner surface 66 of first cylindrical portion 60 of flange 42. Nozzle groove 76 is sized so that connector 70 is simultaneously partially seated in nozzle groove 76 and partially seated in flange groove 78. Since connector 70 is located in both flange groove 78 and nozzle groove 76, flange 42 is secured in a position relative to nozzle 18 in the longitudinal direction and the overall outer dimension of the combined nozzle and flange is reduced.

Although connector 70 has been described and illustrated as a generally C-shaped spring wire having a circular cross-section, other connectors may be used to releasably connect flange 42 to nozzle body 28. The connector may be either deformable or rigid and may have any cross-section. In addition, the connector need not be C-shaped and may be constructed of multiple components. As one alternative, a solid ring may be used to connect the separate parts. In a further alternative, a bump or ball on one part may interface a dimple or groove on the other.

As suggested above, and as best seen in FIGS. 4A and 4B, circumferential nozzle groove 76 is formed in outer surface 68 of nozzle body 28 below nozzle head 26. Similarly, corresponding flange groove 78 is formed in inner surface 66 of the first cylindrical portion 60 of flange 42. As seen in FIG. 4A, showing flange 42 secured to nozzle 18, grooves 76 and 78 are aligned so that connector 70 may extend partially into each of grooves 76 and 78 to secure flange 42 in place. The depth of nozzle groove 76 from the outer surface of nozzle body 28 may be less than the diameter of connector 70, as shown.

The interaction of flange 42, connector 70, and nozzle 18 will now be described in greater detail with reference to FIGS. 2A through 5. As will be apparent from the following description flange 42 is generally either in a secured position or a released position with respect to nozzle 18. Various views of connector 70 and flange 42 secured to nozzle body 28 are shown in FIGS. 2A, 3A, 4A and 5. The released position is illustrated in FIGS. 2B, 3B and 4B.

In order to connect flange 42 to nozzle 18, connector 70 is positioned in flange 42 with fixed and movable ends 80 and 82 extending into hole 84 and slot 86, respectively. Flange 42 is slipped over nozzle tip 30 and slid along nozzle body 28 towards nozzle head 26. As flange 42 is slid along nozzle body 28, movable end 82 is moved in direction 88, which causes connector 70 to fully seat within flange groove 78. As flange 42 is slid further onto nozzle body 28, movable end is held in direction 88 so that flange 42 can be slid over nozzle body 28. When top end 54 of first cylindrical portion 60 abuts shoulder 56 on nozzle head 26 flange groove 78 and nozzle groove 76 are aligned. When the two grooves are aligned, movable end 82 is released causing connector 70 to partially seat within nozzle groove 76. As a result, connector 70 simultaneously is engaged with both nozzle groove 76 and flange groove 78 intersecting inner surface 66 and outer surface 68 and thereby secures the flange to nozzle body 28. Nozzle 18 and flange 42 can then be mounted in, or removed from, mold plate 32 as a unit.

Flange 42 may be released from nozzle body 28 by pushing on movable end 82 of connector 70 in the direction of arrow 88, thereby retracting connector 70 out of nozzle groove 76 and fully into flange groove 78. While movable end 82 is held in the direction of arrow 88, flange 42 is able to freely slide along nozzle body 28 and can be removed.

As will be apparent to those skilled in the art in light of the foregoing disclosure, many alterations and modifications are possible in the practice of this invention without departing from the claimed scope thereof. Accordingly, the scope of the invention is to be construed in accordance with the substance defined by the following claims.

While this invention has been particularly shown and described with reference to preferred embodiments thereof, it will be understood by those skilled in the art that various changes in form and details may be made therein without departing from the spirit and scope of the invention.

What is claimed is:

1. An injection molding apparatus comprising:
a manifold having a manifold melt channel;
a mold plate having a nozzle recess;
a nozzle disposed in the nozzle recess, the nozzle having a nozzle body, an outer surface, and a nozzle head;
a separate flange releasably connected to the nozzle that is disposed adjacent to the nozzle head, the separate flange having an inner surface that abuts the outer surface of the nozzle body; and
a connector that intersects the outer surface of the nozzle body and the inner surface of the flange.

2. The apparatus according to claim 1, wherein the nozzle has an enlarged head.

3. The apparatus according to claim 2, wherein the enlarged nozzle head has a shoulder.

4. The apparatus according to claim 3, wherein the flange is in abutment with the shoulder of the enlarged nozzle head.

5. The apparatus according to claim 1, wherein the nozzle body has a nozzle groove disposed on the outer surface.

6. The apparatus according to claim 5, wherein the separate flange has a flange groove disposed on the inner surface.

7. The apparatus according to claim 6, wherein the connector is disposed in the nozzle groove and the flange groove.

8. The apparatus according to claim 1, wherein the flange is made of a thermally insulative material.

9. The apparatus according to claim 8, wherein the flange is made of titanium.

10. The apparatus according to claim 8, wherein the flange is made of a ceramic material.

11. The apparatus according to claim 1, wherein a portion of the connector is accessible through a wall of the flange when the nozzle body and the flange are connected.

12. The apparatus according to claim 1, further comprising a terminal connector coupled to the nozzle between an upstream end of the flange and an upstream end of the nozzle head.

13. The apparatus according to claim 1, wherein the connector is deformable.

14. The apparatus according to claim 13, wherein the connector is a C-shaped spring wire.

15. An injection molding apparatus comprising:
a manifold having a manifold melt channel;
a mold plate having a nozzle recess;
a nozzle body disposed in the nozzle recess, the nozzle body having a nozzle groove;
a separate flange releasably connected to the nozzle having a flange groove; and
a connector that is disposed partially within the nozzle groove and partially within the flange groove.

16. The apparatus according to claim 15, wherein the flange is made of a thermally insulative material.

17. The apparatus according to claim 16, wherein the flange is made of titanium.

18. The apparatus according to claim 16, wherein the flange is made of a ceramic material.

19. The apparatus according to claim 15, wherein a portion of the connector is accessible through a wall of the flange when the nozzle body and the flange are connected.

20. The apparatus according to claim 15, further comprising a terminal connector coupled to the nozzle between an upstream end of the flange and an upstream end of the nozzle.

21. The apparatus according to claim 15, wherein the connector is deformable.

22. The apparatus according to claim 21, wherein the connector is a C-shaped spring wire.

23. A hot runner nozzle comprising:
a nozzle having a nozzle body, an outer surface, and a nozzle head;
a separate flange releasably connected to the nozzle that is disposed adjacent to the nozzle head, the separate flange having an inner surface that abuts the outer surface of the nozzle body; and
a connector that intersects the outer surface of the nozzle body and the inner surface of the flange.

24. The nozzle according to claim 23, wherein the nozzle has an enlarged head.

25. The nozzle according to claim 24, wherein the enlarged nozzle head has a shoulder.

26. The nozzle according to claim 25, wherein the flange is in abutment with the shoulder of the enlarged nozzle head.

27. The nozzle according to claim 23, wherein the nozzle body has a nozzle groove disposed on the outer surface.

28. The nozzle according to claim 27, wherein the separate flange has a flange groove disposed on the inner surface.

29. The nozzle according to claim 28, wherein the connector is disposed in the nozzle groove and the flange groove.

30. The nozzle according to claim 23, wherein the flange is made of thermally insulative material.

31. The nozzle according to claim 30, wherein the flange is made of titanium.

32. The nozzle according to claim 30, wherein the flange is made of a ceramic material.

33. The nozzle according to claim 23, wherein a portion of the connector is accessible through a wall of the flange when the nozzle body and the flange are connected.

34. The nozzle according to claim 23, further comprising a terminal connector coupled to the nozzle between an upstream end of the flange and an upstream end of the nozzle head.

35. The nozzle according to claim 23, wherein the connector is deformable.

36. The nozzle according to claim 35, wherein the connector is a C-shaped spring wire.

37. An injection molding apparatus comprising:
a manifold having a manifold melt channel;
a mold plate having a nozzle recess;
a nozzle disposed in the nozzle recess, the nozzle having a nozzle body, an outer surface, and a nozzle head;
a separate flange disposed adjacent to the nozzle head, the separate flange having an inner surface that abuts the outer surface of the nozzle body; and
means for releasably connecting the flange to the nozzle body adjacent to the nozzle head that intersects the outer surface of the nozzle body and the inner surface of the flange.

38. The apparatus according to claim 37, wherein the nozzle has an enlarged head.

39. The apparatus according to claim 38, wherein the enlarged nozzle head has a shoulder.

40. The apparatus according to claim 39, wherein the flange is in abutment with the shoulder of the enlarged nozzle head.

41. The apparatus according to claim 37, wherein the means for connecting the flange to the nozzle body includes a nozzle groove disposed on the outer surface of the nozzle body, a flange groove disposed on the inner surface of the flange, and a connector disposed in the nozzle groove and the flange groove.

42. The apparatus according to claim 41, wherein a portion of the connector is accessible through a wall of the flange when the nozzle body and the flange are connected.

43. The apparatus according to claim 41, wherein the connector is deformable.

44. The apparatus according to claim 43, wherein the connector is a C-shaped spring wire.

45. The apparatus according to claim 37, wherein the flange is made of a thermally insulative material.

46. The apparatus according to claim 45, wherein the flange is made of titanium.

47. The apparatus according to claim 45, wherein the flange is made of a ceramic material.

48. The apparatus according to claim 37, further comprising a terminal connector coupled to the nozzle between an upstream end of the flange and an upstream end of the nozzle head.
